(19) United States
(12) Patent Application Publication
(10) Pub. No.: US 2024/0218168 A1
(43) Pub. Date: Jul. 4, 2024

(54) FLUOROELASTOMER COMPOSITION, FORMED ARTICLE AND FUEL HOSE

(71) Applicant: DAIKIN INDUSTRIES, LTD., Osaka (JP)

(72) Inventor: Hiroyuki TANAKA, Osaka (JP)

(73) Assignee: DAIKIN INDUSTRIES, LTD., Osaka (JP)

(21) Appl. No.: 18/396,954

(22) Filed: Dec. 27, 2023

(30) Foreign Application Priority Data
Dec. 28, 2022 (JP) 2022-211934

(51) Int. Cl. C08L 27/16; F16L 11/04

(52) U.S. Cl. CPC C08L 27/16; F16L 11/04; C08L 2205/16; C08L 2207/04

(57) ABSTRACT

Provided is a fluoroelastomer composition comprising a fluoroelastomer and a cellulose nanofiber, wherein a fluorine content of the fluoroelastomer is 61 to 73 mass %, and a content of the cellulose nanofiber is 1 to 50 parts by mass based on 100 parts by mass of the fluoroelastomer.

### CROSS-REFERENCE TO RELATED APPLICATIONS

This application claims the benefit of Japanese Patent Application No. 2022-211934, filed Dec. 28, 2022, which is incorporated herein by reference in their entirety.

### TECHNICAL FIELD

The present disclosure relates to a fluoroelastomer composition, a formed article, and a fuel hose.

### BACKGROUND ART

Japanese Patent Laid-Open No. 2020-045397 describes a fluoroelastomer composition comprising a fluoroelastomer and a filler, wherein the fluoroelastomer has a fluorine content of 65 to 73 mass %, the filler is at least one selected from the group consisting of expanded graphite, plate-like alumina, and plate-like boron nitride, and a content of the filler is 3 to 30 parts by mass based on 100 parts by mass of the fluoroelastomer.

Japanese Patent Laid-Open No. 2010-209275 describes a polymer composition comprising a polymer and a flaky or plate-like filler, wherein the flaky or plate-like filler has an average particle size of 3 μm or less, and the ratio of particles having a particle size of 10 μm or more to particles having a particle size of 1 μm or more is 10% or more.

### SUMMARY

According to the present disclosure, provided is a fluoroelastomer composition comprising a fluoroelastomer and a cellulose nanofiber, wherein a fluorine content of the fluoroelastomer is 61 to 73 mass %, and a content of the cellulose nanofiber is 1 to 50 parts by mass based on 100 parts by mass of the fluoroelastomer.

### Effects

According to the present disclosure, a fluoroelastomer composition from which a formed article excellent in low fuel permeability is obtainable can be provided.

### DESCRIPTION OF EMBODIMENTS

Hereinafter, specific embodiments of the present disclosure will be described in detail, but the present disclosure is in no way limited to the following embodiments.

Japanese Patent Laid-Open No. 2020-045397 proposes, as a fluoroelastomer composition from which a formed article excellent in low fuel permeability can be obtained, a fluoroelastomer composition containing a fluoroelastomer and a filler, such as expanded graphite, plate-like alumina, or plate-like boron nitride. Japanese Patent Laid-Open No. 2010-209275 proposes, as a polymer composition having both of excellent physical property intrinsic to the polymer and low permeability, a polymer composition containing a fluoroelastomer and a flaky filler, such as sericite.

The present disclosure proposes, as a fluoroelastomer composition from which a formed article excellent in low fuel permeability can be obtained, a fluoroelastomer composition containing a fluoroelastomer and a component completely different from a conventional one.

The fluoroelastomer composition of the present disclosure contains a fluoroelastomer and a cellulose nanofiber.

### (Fluoroelastomer)

The fluoroelastomer composition of the present disclosure contains a fluoroelastomer. The fluoroelastomer is an amorphous fluoropolymer. The “amorphous” means that the size of the melting peak (ΔH) appearing in the differential scanning calorimetry [DSC] (temperature-increasing rate 10° C./min) or the differential thermal analysis [DTA] (temperature-increasing rate 10° C./min) is 4.5 J/g or less. By crosslinking, the fluoroelastomer shows elastomeric characteristics. The elastomeric characteristics mean characteristics that a polymer can be stretched, but when a force that is needed to stretch the polymer is no longer applied, the original length of the polymer can be maintained.

From the viewpoints of low fuel permeability and cost, the fluorine content of the fluoroelastomer is preferably 61 to 73 mass %, more preferably 63 mass % or more, still more preferably 65 mass % or more, still much more preferably 67 mass % or more, particularly preferably 69 mass % or more, and more preferably 71 mass % or less. The fluorine content of the fluoroelastomer can be determined by calculation from the formulation of the fluoroelastomer measured by ¹⁹F-NMR.

The fluoroelastomer is preferably a partially fluorinated elastomer. In the present disclosure, the partially fluorinated elastomer is a fluoropolymer containing fluoromonomer unit, wherein a content of perfluoromonomer units based on all the polymerization units is less than 90 mol %, and is a fluoropolymer having a glass transition temperature of 20° C. or lower and having a melting peak (ΔH) size of 4.5 J/g or less.

The fluoroelastomer is more preferably at least one selected from the group consisting of a vinylidene fluoride (VdF)/hexafluoropropylene (HFP) copolymer, a VdF/HFP/tetrafluoroethylene (TFE) copolymer, a TFE/propylene copolymer, a TFE/propylene/VdF copolymer, an ethylene/HFP copolymer, an ethylene/HFP/VdF copolymer, an ethylene/HFP/TFE copolymer, a VdF/TFE/perfluoro(alkyl vinyl ether) (PAVE) copolymer, a VdF/2,3,3,3-tetrafluoropropylene copolymer, and a VdF/chlorotrifluoroethylene (CTFE) copolymer. Among these, a fluoroelastomer composed of a copolymer containing VdF unit is still more preferable.

The fluoroelastomer composed of a copolymer containing vinylidene fluoride (VdF) unit (also referred to as “VdF-based fluoroelastomer” hereinafter) will be described. The VdF-based fluoroelastomer is a fluoroelastomer containing a polymerization unit derived from at least VdF.

The copolymer containing VdF unit is preferably a copolymer containing VdF unit and a polymerization unit derived from a fluorine-containing ethylenic monomer (however, VdF unit is excluded). The copolymer containing VdF unit also preferably further contains a polymerization unit derived from a monomer copolymerizable with VdF and a fluorine-containing ethylenic monomer.

The copolymer containing VdF unit preferably contains 30 to 85 mol % of VdF unit and 70 to 15 mol % of a polymerization unit derived from a fluorine-containing ethylenic monomer, and more preferably contains 30 to 80 mol % of VdF unit and 70 to 20 mol % of a polymerization unit derived from a fluorine-containing ethylenic monomer. The amount of the polymerization unit derived from a monomer copolymerizable with VdF and a fluorine-containing ethylenic monomer is preferably 0 to 10 mol %.

Examples of the fluorine-containing ethylenic monomers include fluorine-containing monomers, such as tetrafluoroethylene (TFE), hexafluoropropylene (HFP), perfluoro(alkyl vinyl ether) (PAVE), fluoroalkyl vinyl ether, chlorotrifluoroethylene (CTFE), trifluoroethylene, trifluoropropylene, pentafluoropropylene, trifluorobutene, tetrafluoroisobutene, hexafluoroisobutene, vinyl fluoride, a fluoromonomer represented by the general formula: CHX¹═CX²Rf¹ (wherein one of X¹ and X² is H, and the other is F, and Rf¹ is a straight-chain or branched fluoroalkyl group having 1 to 12 carbon atoms), a fluoromonomer represented by the general formula: CH₂═CH—(CF₂)ₙ—X³ (wherein X³ is H or F, and n is an integer of 3 to 10), and a monomer that gives a crosslinking site. Among these, preferable is at least one selected from the group consisting of TFE, HFP, PAVE, CTFE, and 2,3,3,3-tetrafluoropropylene, and more preferable is at least one selected from the group consisting of TFE, HFP, and PAVE.

The above PAVE is preferably at least one selected from the group consisting of the general formula:

CF₂═CFO(CF₂CFX⁴O)ₚ—(CF₂CF₂CF₂O)_{q}—Rf²

wherein X⁴ represents F or CF₃, Rf² represents a perfluoroalkyl group having 1 to 5 carbon atoms, p represents an integer of 0 to 5, and q represents an integer of 0 to 5); and the general formula:

CFX═CXOCF₂OR¹

wherein each X is the same or different and represents H, F or CF₃, and R¹ represents a straight-chain or branched fluoroalkyl group having 1 to 6 carbon atoms, which may contain 1 to 2 atoms of at least one type selected from the group consisting of H, Cl, Br and I, or a cyclic fluoroalkyl group having 5 or 6 carbon atoms, which may contain 1 to 2 atoms of at least 1 type selected from the group consisting of H, Cl, Br and I.

The above PAVE is more preferably perfluoro(methyl vinyl ether) or perfluoro(propyl vinyl ether), and still more preferably perfluoro(methyl vinyl ether). These can be each used alone or in optional combination.

The monomer copolymerizable with VdF and the fluorine-containing ethylenic monomer is, for example, a non-fluorinated monomer, such as ethylene, propylene, or alkyl vinyl ether.

Such a copolymer containing VdF unit is specifically and preferably one or more of a VdF/HFP copolymer, a VdF/HFP/TFE copolymer, a VdF/CTFE copolymer, a VdF/CTFE/TFE copolymer, a VdF/PAVE copolymer, a VdF/TFE/PAVE copolymer, a VdF/HFP/PAVE copolymer, a VdF/HFP/TFE/PAVE copolymer, and a VdF/2,3,3,3-tetrafluoropropylene copolymer. Among these copolymers containing VdF unit, particularly preferable is at least one selected from the group consisting of a VdF/HFP copolymer and a VdF/HFP/TFE copolymer from the viewpoints of heat resistance, non-stickiness, and flexibility.

The VdF/HFP copolymer is preferably one having a VdF/HFP mole ratio of 45 to 85/55 to 15, more preferably 50 to 80/50 to 20, and still more preferably 60 to 80/40 to 20.

The VdF/HFP/TFE copolymer is preferably one having a VdF/HFP/TFE mole ratio of 40 to 80/10 to 35/10 to 35.

The VdF/PAVE copolymer is preferably one having a VdF/PAVE mole ratio of 65 to 90/10 to 35.

The VdF/TFE/PAVE copolymer is preferably one having a VdF/TFE/PAVE mole ratio of 40 to 80/3 to 40/15 to 35.

The VdF/HFP/PAVE copolymer is preferably one having a VdF/HFP/PAVE mole ratio of 65 to 90/3 to 25/3 to 25.

The VdF/HFP/TFE/PAVE copolymer is preferably one having a VdF/HFP/TFE/PAVE mole ratio of 40 to 90/0 to 25/0 to 40/3 to 35, and more preferably 40 to 80/3 to 25/3 to 40/3 to 25.

The VdF/2,3,3,3-tetrafluoropropylene copolymer is preferably one having a VdF/2,3,3,3-tetrafluoropropylene mole ratio of 45 to 85/55 to 15, more preferably 50 to 80/50 to 20, and still more preferably 60 to 80/40 to 20.

The fluoroelastomer is preferably composed of a copolymer containing a polymerization unit derived from a monomer that gives a crosslinking site. Examples of the monomers that give a crosslinking site include such an iodine-containing monomer as described in Japanese Patent Publication No. 5-63482 or Japanese Patent Laid-Open No. 7-316234, such as perfluoro(6,6-dihydro-6-iodo-3-oxa-1-hexene) or perfluoro(5-iodo-3-oxa-1-pentene), a bromine-containing monomer described in Japanese Translation of PCT International Application Publication No. 1992-505341, such a cyano group-containing monomer as described in Japanese Translation of PCT International Application Publication No. 1992-505345 or Japanese Translation of PCT International Application Publication No. 1993-500070, a carboxyl group-containing monomer, and an alkoxycarbonyl group-containing monomer.

For example, the fluoroelastomer may be one obtained by using a chain transfer agent during polymerization. The chain transfer agent may be a bromine compound or an iodine compound. The polymerization method that is carried out using a bromine compound or an iodine compound is, for example, a method in which emulsion polymerization is carried out in an aqueous medium in the presence of a bromine compound or an iodine compound in a substantially oxygen-free state, while applying pressure (iodine transfer polymerization method). A typical example of the bromine compound or the iodine compound used is a compound represented by the general formula:

R²IₓBr_{y}

wherein x and y are each an integer of 0 to 2 and satisfy 1≤x+y≤2, and R² is a saturated or unsaturated fluorohydrocarbon group or chlorofluorohydrocarbon group having 1 to 16 carbon atoms or a hydrocarbon group having 1 to 3 carbon atoms, and may contain an oxygen atom). By using a bromine compound or an iodine compound, iodine or bromine is introduced into a polymer and functions as a crosslinking point.

Examples of the fluoroelastomers include a peroxide-crosslinkable fluoroelastomer, a polyol-crosslinkable fluoroelastomer, and a polyamine-crosslinkable fluoroelastomer. The fluoroelastomer is preferably a peroxide-crosslinkable fluoroelastomer or a polyol-crosslinkable fluoroelastomer.

The peroxide-crosslinkable fluoroelastomer is not limited as long as it is a fluoroelastomer having a peroxide-crosslinkable site. Examples of the peroxide-crosslinkable sites include, but not limited to, an iodine atom and a bromine atom. When the fluoroelastomer contains an iodine atom, an iodine content is preferably 0.001 to 10 mass %, more preferably 0.01 mass % or more, preferably 0.1 mass % or more, and more preferably 5 mass % or less.

The polyol-crosslinkable fluoroelastomer is not limited as long as it is a fluoroelastomer having a polyol-crosslinkable site. The polyol-crosslinkable site is not limited, and is, for example, a site having vinylidene fluoride (VdF) unit. A method for introducing the crosslinking site is, for example, a method in which a monomer that gives a crosslinking site is copolymerized during polymerization for a fluoroelastomer.

Mooney viscosity of the fluoroelastomer at 100° C. (ML1+10(100° C.)) is preferably 2 or more, more preferably 5 or more, and still more preferably 10 or more. It is preferably 200 or less, more preferably 120 or less, still more preferably 100 or less, and particularly preferably 80 or less. The Mooney viscosity is a value measured in accordance with ASTM-D1646-15 and JIS K-6300-1:2013.

### (Cellulose Nanofiber)

The cellulose nanofiber is an ultrafine fiber using cellulose as a raw material. The cellulose nanofiber may be unmodified cellulose nanofiber, or may be a modified cellulose nanofiber using modified cellulose as a raw material.

The modified cellulose is obtained by modifying cellulose. Examples of the modified cellulose include carboxylated cellulose, carboxymethylated cellulose, cationized cellulose, and esterified cellulose. The carboxymethylated cellulose is distinguished from carboxymethyl cellulose in that when the carboxymethylated cellulose is dispersed in water, at least a part of it maintains the shape of a fiber. Observation of a water dispersion with an electron microscope can demonstrate that the shape of a fiber is maintained in the water dispersion.

For example, an average fiber diameter of the cellulose nanofibers may be 3 nm to 10 μm, or may be 3 to 500 nm. The average fiber diameter of the cellulose nanofibers is determined by measuring fiber diameters of 10 fibers using a scanning electron microscope (SEM), an atomic force microscope (AFM), or a transmission electron microscope (TEM) and averaging the measured values.

An aspect ratio (average fiber length/average fiber diameter) of the cellulose nanofiber is preferably 50 to 1,000. The average fiber diameter and the average fiber length of the cellulose nanofibers can be determined by measuring fiber diameters and fiber lengths of 10 fibers using a scanning electron microscope (SEM), an atomic force microscope (AFM), or a transmission electron microscope (TEM) and averaging the measured values.

In the present disclosure, cellulose nanofiber obtained by a known manufacturing method can be used. When the cellulose nanofiber is compounded with the fluoroelastomer, a powder of the cellulose nanofiber may be compounded with the fluoroelastomer, or a water dispersion of the cellulose nanofiber may be compounded with fluoroelastomer. Alternatively, the fluoroelastomer composition may be prepared by preparing a water dispersion containing the fluoroelastomer and the cellulose nanofiber and then co-coagulating the fluoroelastomer and the cellulose nanofiber in the water dispersion.

A content of the cellulose nanofiber is 1 to 50 parts by mass, preferably 2 parts by mass or more, more preferably 3 parts by mass or more, and preferably 40 parts by mass or less, more preferably 30 parts by mass or less, still more preferably 20 parts by mass or less, and still much more preferably 15 parts by mass or less, based on 100 parts by mass of the fluoroelastomer. When the content of the cellulose nanofiber is too low, it becomes difficult to obtain a formed article excellent in low fuel permeability, and when the content of the cellulose nanofiber is too high, there is a risk that excellent property of the fluoroelastomer, such as heat resistance, may not be sufficiently exhibited.

### (Crosslinking Agent)

The fluoroelastomer composition of the present disclosure preferably further contains a crosslinking agent. The type of the crosslinking agent is not limited, and the crosslinking agent can be appropriately selected according to the type of the fluoroelastomer and the melting/kneading conditions.

When a crosslinkable group (cure site) is contained in the fluoroelastomer, the crosslinking agent is appropriately selected according to the type of the cure site or the usage of the resulting formed article. Any of crosslinking types of polyamine crosslinking type, polyol crosslinking type, peroxide crosslinking type, imidazole crosslinking type, triazine crosslinking type, oxazole crosslinking type, and thiazole crosslinking type can be adopted.

The crosslinking agent is preferably at least one selected from the group consisting of a polyamine crosslinking agent, a polyol crosslinking agent, and a peroxide crosslinking agent, and more preferably at least one selected from the group consisting of a polyol crosslinking agent and a peroxide crosslinking agent, because a formed article further excellent in low fuel permeability can be obtained.

Examples of the polyamine crosslinking agents include polyamine compounds, such as hexamethylenediamine carbamate, N,N′-dicynnamylidene-1,6-hexamethylenediamine, and 4,4′-bis(aminocyclohexyl)methane carbamate. Among these, N,N′-dicynnamylidene-1,6-hexamethylenediamine is preferable.

The polyol crosslinking agent may be a compound conventionally known as a crosslinking agent for a fluoroelastomer, and for example, a polyhydroxy compound, particularly a polyhydroxy aromatic compound, is preferably used because it is excellent in heat resistance.

Examples of the polyhydroxy aromatic compounds include, but not limited to, 2,2-bis(4-hydroxyphenyl)propane (referred to as bisphenol A hereinafter), 2,2-bis(4-hydroxyphenyl)perfluoropropane (referred to as bisphenol AF hereinafter), 1,3-dihydroxybenzene, 1,7-dihydroxynaphthalene, 2,7-dihydroxynaphthalene, 1,6-dihydroxynaphthalene, 4,4′-dihydroxydiphenyl, 4,4′-dihydroxystilbene, 2,6-dihydroxyanthracene, hydroquinone, catechol, 2,2-bis(4-hydroxyphenyl)butane (referred to as bisphenol B hereinafter), 4,4-bis(4-hydroxyphenyl)benzoate, 2,2-bis(4-hydroxyphenyl)tetrafluorodichloropropane, 4,4′-dihydroxydiphenylsulfone, 4,4′-dihydroxydiphenyl ketone, tri(4-hydroxyphenyl)methane, 3,3′,5,5′-tetrachlorobisphenol A, 3,3′,5,5′-tetrabromobisphenol A, and diaminobisphenol AF. For example, these polyhydroxy aromatic compounds may be alkali metal salts, alkaline earth metal salts, and the like, but when the copolymer has been coagulated using an acid, it is preferable not to use the above metal salts.

Among these, a polyhydroxy compound is preferable from the viewpoint that the resulting formed article, etc. have low permanent compression set and excellent moldability, and from the viewpoint that heat resistance is excellent, a polyhydroxy aromatic compound is more preferable, and bisphenol AF is still more preferable.

The crosslinking agent of the peroxide crosslinking type is an organic peroxide capable of easily generating a peroxide radical in the presence of heat or oxidation-reduction system, and specific examples thereof include 1,1-bis(t-butylperoxy)-3,5,5-trimethylcyclohexane, 2,5-dimethylhexane-2,5-dihydroperoxide, di-t-butyl peroxide, t-butyl cumyl peroxide, dicumyl peroxide, α,α-bis(t-butylperoxy)-p-diisopropylbenzene, 2,5-dimethyl-2,5-di(t-butylperoxy)hexane, 2,5-dimethyl-2,5-di(t-butylperoxy)hexyne-3, benzoyl peroxide, t-butyl peroxybenzene, t-butylperoxymaleic acid, and t-butylperoxyisopropyl carbonate. Among these, preferable is 2,5-dimethyl-2,5-di(t-butylperoxy)hexane.

The amount of the crosslinking agent added is preferably 0.05 to 10 parts by mass, more preferably 0.1 to 10 parts by mass, still more preferably 0.3 to 7 parts by mass, and particularly preferably 1 to 5 parts by mass, based on 100 parts by mass of the fluoroelastomer. If the amount of the crosslinking agent is too small, the degree of crosslinking is insufficient, so that performance of the formed article, such as heat resistance and oil resistance, tends to be impaired, and if the amount of the crosslinking agent is too large, the crosslink density becomes too high, so that the crosslinking time tends to become longer, in addition, it is economically disadvantageous, and forming processability of the resulting fluoroelastomer composition tends to decrease.

In the polyol crosslinking type, a crosslinking aid is usually used in combination with the polyol crosslinking agent. When the crosslinking aid is used, the crosslinking reaction can be accelerated by accelerating formation of an intramolecular double bond in the dehydrofluorination reaction of a fluoroelastomer main chain.

Generally, an onium compound is used as the crosslinking aid of the polyol crosslinking type. Examples of the onium compounds include, but not limited to, an ammonium compound such as a quaternary ammonium salt, a phosphonium compound such as a quaternary phosphonium salt, an oxonium compound, a sulfonium compound, a cyclic amine, and a monofunctional amine compound. Among these, a quaternary ammonium salt and a quaternary phosphonium salt are preferable.

Specific examples thereof include quaternary ammonium salts, such as tetrabutylammonium bromide, tetrabutylammonium chloride, benzyltributylammonium chloride, benzyltriethylammonium chloride, tetrabutylammonium hydrogen sulfate, and tetrabutylammonium hydroxide; cyclic amines, such as 8-methyl-1,8-diazabicyclo[5,4,0]-7-undecenium chloride, 8-methyl-1,8-diazabicyclo[5,4,0]-7-undecenium iodide, 8-methyl-1,8-diazabicyclo[5,4,0]-7-undecenium hydroxide, 8-methyl-1,8-diazabicyclo[5,4,0]-7-undecenium methylsulfate, 8-ethyl-1,8-diazabicyclo[5,4,0]-7-undecenium bromide, 8-propyl-1,8-diazabicyclo[5,4,0]-7-undecenium bromide, 8-dodecyl-1,8-diazabicyclo[5,4,0]-7-undecenium chloride, 8-dodecyl-1,8-diazabicyclo[5,4,0]-7-undecenium hydroxide, 8-eicosyl-1,8-diazabicyclo[5,4,0]-7-undecenium chloride, 8-tetracosyl-1,8-diazabicyclo[5,4,0]-7-undecenium chloride, 8-benzyl-1,8-diazabicyclo[5,4,0]-7-undecenium chloride (referred to as DBU-B hereinafter), 8-benzyl-1,8-diazabicyclo[5,4,0]-7-undecenium hydroxide, 8-phenethyl-1,8-diazabicyclo[5,4,0]-7-undecenium chloride, 8-(3-phenylpropyl)-1,8-diazabicyclo[5,4,0]-7-undecenium chloride, and 1,8-diazabicyclo[5,4,0]-undec-7-ene; monofunctional amines, such as benzylmethylamine and benzylethanolamine; and quaternary phosphonium salts, such as tetrabutylphosphonium chloride, benzyltriphenylphosphonium chloride (referred to as BTPPC hereinafter), benzyltrimethylphosphonium chloride, benzyltributylphosphonium chloride, tributylallylphosphonium chloride, tributyl-2-methoxypropylphosphonium chloride, and benzylphenyl(dimethylamino)phosphonium chloride.

Among these, DBU-B and BTPPC are preferable from the viewpoints of crosslinkability and physical property of the crosslinked product.

The crosslinking aid may be a quaternary ammonium salt, a solid solution of a quaternary phosphonium salt and bisphenol AF, or a chlorine-free crosslinking aid disclosed in Japanese Patent Laid-Open No. 11-147891.

Examples of the crosslinking aids for the organic peroxide include triallyl cyanurate, triallyl isocyanurate (TAIC), triacrylformal, triallyl trimellitate, N,N′-m-phenylene bismaleimide, dipropargyl terephthalate, diallyl phthalate, tetraallyl terephthalate amide, triallyl phosphate, bismaleimide, fluorinated triallyl isocyanurate (1,3,5-tris(2,3,3-trifluoro-2-propenyl)-1,3,5-triazine-2,4,6-trione), tris(diallylamine)-S-triazine, triallyl phosphite, N,N-diallylacrylamide, 1,6-divinyldodecafluorohexane, hexaallylphosphoramide, N,N,N′,N′-tetraallylphthalamide, N,N,N′,N′-tetraallylmalonamide, trivinyl isocyanurate, 2,4,6-trivinylmethyltrisiloxane, tri(5-norbonene-2-methylene)cyanurate, and triallyl phosphite. Among these, triallyl isocyanurate (TAIC) is preferable from the viewpoints of crosslinkability and physical property of the crosslinked product.

The amount of the crosslinking aid of the polyol crosslinking type added is preferably 0.1 to 5 parts by mass, more preferably 0.1 to 3 parts by mass, still more preferably 0.2 to 2 parts by mass, and particularly preferably 0.1 to 1 part by mass, based on 100 parts by mass of the fluoroelastomer. If the amount of the crosslinking aid is too small, the crosslinking time becomes too long to be practical, and heat resistance and oil resistance of the resulting formed article tend to decrease, and if the amount of the crosslinking aid is too large, the crosslinking time becomes too fast, in addition, permanent compression set of the formed article is reduced, and forming processability of the resulting fluoroelastomer composition tends to decrease.

The amount of the crosslinking aid for the organic peroxide added is preferably 0.1 to 20 parts by mass, more preferably 0.1 to 10 parts by mass, still more preferably 0.3 to 10 parts by mass, and particularly preferably 0.5 to 5 parts by mass, based on 100 parts by mass of the fluoroelastomer. If the amount of the crosslinking aid is too small, the crosslinking time becomes too long to be practical, and heat resistance and oil resistance of the resulting formed article tend to decrease, and if the amount of the crosslinking aid is too large, the crosslinking time becomes too fast, in addition, permanent compression set of the formed article is reduced, and forming processability of the resulting fluoroelastomer composition tends to decrease.

### (Other Components)

The fluoroelastomer composition of the present disclosure may contain an acid acceptor. Examples of the acid acceptors include metal oxides, such as magnesium oxide, calcium oxide, and bismuth oxide, metal hydroxides, such as calcium hydroxide, synthetic hydrotalcites, and sodium metasilicate.

A content of the acid acceptor is preferably 0.5 to 30 parts by mass, more preferably 1 part by mass or more, and more preferably 15 parts by mass or less, based on 100 parts by mass of the fluoroelastomer.

To the fluoroelastomer composition of the present disclosure, additives usually compounded into a fluoroelastomer composition when needed, for example, various additives, such as a filler (carbon black, bituminous coal, barium sulfate, diatomaceous earth, sintered clay, talc, wollastonite, carbon nanotube, or the like), a processing aid (wax, or the like), a plasticizer, a colorant, a stabilizer, a tackifier (coumarone resin, coumarone/indene resin, or the like), a mold release agent, a conductivity imparting agent, a thermal conductivity imparting agent, a surface non-tackifying agent, a flexibilizer, a heat resistance improver, a flame retarder, a foaming agent, and an antioxidant described in International Publication No. WO 2012/023485, can be compounded, and one or more of commonly used crosslinking agents and crosslinking accelerators that are different from the aforementioned ones may be compounded.

Examples of the fillers (however, cellulose nanofiber is excluded) include metal oxides, such as titanium oxide and aluminum oxide; metal hydroxides, such as magnesium hydroxide and aluminum hydroxide; carbonates, such as magnesium carbonate, aluminum carbonate, calcium carbonate, and barium carbonate; silicates, such as magnesium silicate, calcium silicate, and aluminum silicate; sulfates, such as aluminum sulfate, calcium sulfate, and barium sulfate; metal sulfides, such as molybdenum disulfide, iron sulfide, and copper sulfide; diatomaceous earth, asbestos, lithopone (zinc sulfide/barium sulfide), graphite, fluorinated carbon, fluorinated calcium, coke, quartz fine powder, talc, mica powder, wollastonite, carbon fiber, aramid fiber, various whiskers, glass fiber, an organic reinforcing agent, an organic filler, polytetrafluoroethylene, a fluorine-containing thermoplastic resin, mica, silica, celite, and clay.

The carbon black is preferably thermal carbon black or furnace carbon black, and is more preferably MT carbon black, FT carbon black, or SRF carbon black. When carbon black or carbon black having a relatively large particle size, such as ET carbon, is compounded, a formed article excellent in permanent compression set characteristics is obtained, and when carbon black having a small particle size is compounded, a formed article excellent in strength or elongation is obtained. By compounding different grades in combination, the above characteristics can be balanced.

A content of the filler such as carbon black is not limited, but is preferably 0 to 300 parts by mass, more preferably 1 to 150 parts by mass, still more preferably 2 to 100 parts by mass, and particularly preferably 2 to 75 parts by mass, based on 100 parts by mass of the fluoroelastomer.

A content of the processing aid such as wax is preferably 0 to 10 parts by mass, and still more preferably 0 to 5 parts by mass, based on 100 parts by mass of the fluoroelastomer. If a processing aid, a plasticizer, or a mold release agent is used, mechanical property or sealability of the resulting formed article tends to decrease, and therefore, their contents need to be adjusted within the range in which the characteristics of the desired formed article obtained are acceptable.

The fluoroelastomer composition of the present disclosure may contain a dialkyl sulfone compound. Examples of the dialkyl sulfone compounds include dimethyl sulfone, diethyl sulfone, dibutyl sulfone, methyl ethyl sulfone, diphenyl sulfone, and sulfolane. A content of the dialkyl sulfone compound is preferably 0 to 10 parts by mass, still more preferably 0 to 5 parts by mass, and particularly preferably 0 to 3 parts by mass, based on 100 parts by mass of the fluoroelastomer. When the fluoroelastomer composition of the present disclosure contains the dialkyl sulfone compound, the lower limit of the content of the dialkyl sulfone compound may be, for example, 0.1 part by mass or more, based on 100 parts by mass of the fluoroelastomer.

The fluoroelastomer composition of the present disclosure can be manufactured by mixing the fluoroelastomer, the cellulose nanofiber, and other desired materials using open rolls, a Banbury mixer, a kneader, or the like. In addition, it can also be prepared by a method of using an internal mixer, or a method including carrying out co-coagulation from emulsion mixing. If desired, a crosslinking agent, additives, etc. may be mixed.

The fluoroelastomer composition of the present disclosure may further contain a fluorine-containing resin. In this case, from the viewpoint that the fluoroelastomer is homogeneously dispersed in the fluorine-containing resin, it is preferable to dynamically crosslink the fluoroelastomer while the fluorine-containing resin is in a molten state, thereby preparing a crosslinked fluoroelastomer in which at least a part of the fluoroelastomer has been crosslinked.

Here, carrying out the dynamic crosslinking treatment means that melt kneading of the fluoroelastomer and dynamic crosslinking thereof are carried out at the same time using a Banbury mixer, a pressure kneader, an extruder, or the like. Among these, an extruder such as a twin-screw extruder is preferably used because high shear force can be added.

The molten state means a state where the fluorine-containing resin is under the temperature at which the fluorine-containing resin is melted. The temperature at which the fluorine-containing resin is melted varies depending upon the glass transition temperature and/or the melting point of the fluorine-containing resin, but it is preferably 120 to 330° C., and more preferably 130 to 320° C. If the temperature is lower than 120° C., dispersion between the fluorine-containing resin and the fluoroelastomer tends to become coarser, and if the temperature exceeds 330° C., the fluoroelastomer tends to be thermally deteriorated.

The resulting fluoroelastomer composition can have a structure in which the fluorine-containing resin forms a continuous phase and the crosslinked fluoroelastomer forms a dispersed phase, or a structure in which the fluorine-containing resin and the crosslinked fluoroelastomer form a bicontinuity phase, and among them, the fluoroelastomer composition preferably has a structure in which the fluorine-containing resin forms a continuous phase and the crosslinked fluoroelastomer forms a dispersed phase.

Even in the case where the fluoroelastomer has formed a matrix at the beginning of dispersing, the fluoroelastomer changes to a crosslinked fluoroelastomer as the crosslinking reaction proceeds, and the crosslinked fluoroelastomer forms a dispersed phase, or the fluorine-containing resin and the crosslinked fluoroelastomer form a bicontinuous structure because the melt viscosity of the crosslinked fluoroelastomer is higher than that of the uncrosslinked fluoroelastomer.

When such a structure is formed, the fluoroelastomer composition of the present disclosure not only exhibits excellent heat resistance, chemical resistance and oil resistance but also has low permeability and good forming processability. In this case, an average dispersed particle size of the crosslinked fluoroelastomer is preferably 0.01 to 30 μm. If the average dispersed particle size is less than 0.01 μm, flowability tends to decrease, and if it exceeds 30 μm, strength of the resulting formed article tends to decrease.

The fluoroelastomer composition of the present disclosure may contain a bicontinuous structure of the fluorine-containing rein and the crosslinked fluoroelastomer in a part of a structure in which the fluorine-containing resin forms a continuous phase and the crosslinked fluoroelastomer forms a dispersed phase.

A fluorine-containing resin/crosslinked fluoroelastomer weight ratio is preferably 98/2 to 30/70, more preferably 95/5 to 40/60, and still more preferably 90/10 to 50/50. If the amount of the fluorine-containing resin is too large, sufficient flexibility tends to be unable to be imparted, and if the amount of the fluorine-containing resin is too small, the crosslinked fluoroelastomer is not homogeneously dispersed and partially becomes bicontinuous, so that the mechanical strength of the composition itself tends significantly decrease, or the flowability tends to significantly decrease.

### (Formed Article)

By forming the fluoroelastomer composition of the present disclosure, various formed articles can be obtained. The formed article obtained from the fluoroelastomer composition of the present disclosure is also one of the present disclosures. The formed article of the present disclosure is preferably one obtained by crosslinking the above fluoroelastomer composition.

The forming can be carried out by a conventionally known method, and examples of the methods include compression molding, injection molding, extrusion forming, and calendaring, or dissolution in a solvent followed by dip forming, coating, or the like.

When various formed articles are obtained from the fluoroelastomer composition of the present disclosure, the fluoroelastomer composition may go through a step of crosslinking. The crosslinking conditions vary depending upon the forming method or the shape of the formed article, but in general, 100 to 200° C. in the range of several seconds to 180 minutes. In order to stabilize the physical property of the crosslinked product, secondary crosslinking may be carried out. As the secondary crosslinking conditions, 150 to 300° C. for about 30 minutes to 30 hours.

A laminate including a layer formed from the fluoroelastomer composition of the present disclosure and at least one layer containing another material can also be prepared. As the “another material”, appropriate one is selected according to the characteristics required, the usage expected, etc., and examples thereof include thermoplastic polymers, such as polyolefin (e.g., high-density polyethylene, medium-density polyethylene, low-density polyethylene, linear low-density polyethylene, an ethylene-propylene copolymer, polypropylene), nylon, polyester, a vinyl chloride resin (PVC), and a vinylidene chloride resin (PVDC), crosslinked elastomers, such as an ethylene-propylene-diene elastomer, a butyl elastomer, a nitrile elastomer, a silicone elastomer, an acrylic elastomer, an acrylonitrile butadiene elastomer, and an epichlorohydrin elastomer, a metal, glass, wood, and a ceramic.

Between the layer formed from the fluoroelastomer composition of the present disclosure and the layer formed from another material, an adhesive layer may be interposed. By interposing the adhesive layer, the layer containing the fluoroelastomer composition of the present disclosure and the layer containing another material can be firmly joined and integrated. Examples of adhesives used for the adhesive layer include an acid anhydride modified product of a diene-based polymer; an acid anhydride modified product of polyolefin; and a mixture of a polymer polyol (e.g., polyester polyol obtained by polycondensing a glycol compound, such as ethylene glycol or propylene glycol, and a dibasic acid, such as adipic acid; and a partially saponified product of a copolymer of vinyl acetate and vinyl chloride), and a polyisocyanate compound (e.g., a reaction product of a glycol compound, such as 1,6-hexamethylene glycol, and a diisocyanate compound, such as 2,4-tolylene diisocyanate, in a mole ratio of 1:2; and a reaction product of a triol compound, such as trimethylpropane, and a diisocyanate compound, such as 2,4-tolylene diisocyanate, in a mole ratio of 1:3). For forming the laminate structure, a known method, such as co-extrusion, co-injection, or extrusion coating, can also be used.

When a laminate having a layer formed from the fluoroelastomer composition of the present disclosure and a layer formed from another material is prepared, the layer formed from the fluoroelastomer composition of the present disclosure may be subjected to surface treatment, as needed. The type of the surface treatment is in no way limited as long as the treatment enables adhesion, and examples include discharge treatment, such as plasma discharge treatment or corona discharge treatment, and a metallic sodium/naphthalene liquid treatment of wet process. The surface treatment is also preferably primer treatment. The primer treatment can be carried out in accordance with a usual way. When the primer treatment is carried out, the surface of the layer formed from the fluoroelastomer composition having been subjected to no surface treatment can also be subjected to primer treatment, but it is more effective to further carry out primer treatment on the surface of the layer formed from the fluoroelastomer composition having been subjected to plasma discharge treatment, corona discharge treatment, metallic sodium/naphthalene liquid treatment, or the like in advance.

A formed article formed from the fluoroelastomer composition of the present disclosure can be preferably used in fields, e.g., a semiconductor related field such as semiconductor manufacturing equipment, liquid crystal panel manufacturing equipment, plasma panel manufacturing equipment, a plasma address liquid crystal panel, a field emission display panel, and a solar cell substrate; an automotive field; an aircraft field; a rocket field; a ship field; a chemical product field such as a plant; a pharmaceutical field such as a medical product; a photography field such as a developing machine; a printing field such as a printing machine; a paint field such as painting equipment; an analytical/physical and chemical equipment field; a food plant equipment field; a nuclear plant equipment field; a steel field such as iron plate processing equipment; a general industrial field; an electric field; and a fuel cell field, and the formed article can be more preferably used in the automotive field among these.

In the automotive field, a gasket, a shaft seal, a valve stem seal, a sealing material, and a hose can be used for an engine and peripheral equipment; a hose and a sealing material can be used for AT equipment; and an O- (square) ring, a tube, a packing, a valve core material, a hose, a sealing material, and a diaphragm can be used for a fuel system and peripheral equipment. Specifically, the formed article can be used as an engine head gasket, a metal gasket, an oil pan gasket, a crank shaft seal, a camshaft seal, a valve stem seal, a manifold packing, an oil hose, an oxygen sensor seal, an ATF hose, an injector O-ring, an injector packing, a fuel pump O-ring, a diaphragm, a fuel hose, a crank shaft seal, a gear box seal, a power piston packing, a seal of a cylinder line, a seal of a valve stem, a front pump seal of automatic transmission, a rear axle pinion seal, a gasket of a universal joint, a pinion seal of a speed meter, a piston cup of a foot brake, an O-ring of torque transmission, an oil seal, a seal of an exhaust gas reburing device, a bearing seal, an EGR tube, a twin cab tube, a diaphragm for carburetor sensor, an anti-vibration rubber (engine mount, exhaust part, etc.), a hose for reburing device, an oxygen sensor bush, or the like.

The fluoroelastomer composition of the present disclosure is particularly preferable for usage requiring low fuel permeability, and can be utilized as, for example, a fluoroelastomer composition for fuel hose. The formed article of the present disclosure is particularly preferable for usage requiring low fuel permeability, and can be utilized as, for example, a fuel hose. Examples of the fuel hoses include an automotive fuel hose, a marine fuel hose, an industrial fuel hose, and a fuel hose for electric generator.

Hereinbefore, the embodiments have been described, and it will be understood that various modifications of forms and details are possible without departing from the sprit and the scope of the patent claims.
<1> According to the first aspect of the present disclosure, provided is a fluoroelastomer composition comprising
a fluoroelastomer and a cellulose nanofiber, wherein
the fluoroelastomer has a fluorine content of 61 to 73 mass %, and
a content of the cellulose nanofiber is 1 to 50 parts by mass based on 100 parts by mass of the fluoroelastomer.
<2> According to the second aspect of the present disclosure, provided is the fluoroelastomer composition according to the first aspect, wherein an average fiber diameter of the cellulose nanofiber is 3 to 500 nm.
<3> According to the third aspect of the present disclosure, provided is the fluoroelastomer composition according to the first or the second aspect, further comprising a crosslinking agent.
<4> According to the fourth aspect of the present disclosure, provided is a formed article obtained from the fluoroelastomer composition according to any one of the first to the third aspects.
<5> According to the fifth aspect of the present disclosure, provided is a fuel hose obtained from the fluoroelastomer composition according to any one of the first to the third aspects.

### EXAMPLES

Next, the embodiments of the present disclosure will be described with reference to examples, but the present disclosure is not limited to the examples only.

The numerical values in the examples were measured by the following methods.

### <Fluorine Content>

Fluorine content was determined by calculation from the formulation of a fluoroelastomer measured by ¹⁹F-NMR.

### <Mooney Viscosity>

Mooney viscosity was measured in accordance with ASTM D1646-15 and JIS K6300-1:2013. The measurement temperature was 100° C.

### <Ordinary-State Property>

Using a formed article having a thickness of 2 mm, a 100% tensile stress, a tensile strength, and an elongation at 23° C. were measured by the use of a tensile testing machine (TENSILON RTG-1310 manufactured by A&D Company, Limited) under the conditions of 500 mm/min with No. 6 dumbbell in accordance with JIS K6251-1:2015.

### <Hardness (Shore A)>

Using three formed articles each having a thickness of 2 mm, which were superposed one upon another, a hardness (peak value) was measured by the use of a type A durometer in accordance with JIS K6253-3:2012.

### <Fuel Permeability>

In a SUS container having a volume of 70 mL (opening area 1.26×10⁻³ m²), 50 mL of CE10 (toluene/isooctane/ethanol=45/45/10 volume %) as simulated fuel was placed, then a sheet-like formed article having a thickness of 0.5 mm was set in the container, and the container was sealed, thereby preparing a specimen. The specimen was placed in a constant-temperature device (40° C.) in such a manner that the sheet was on the lower side and that the simulated fuel came into contact with liquid, then a weight of the specimen was measured, and when the weight loss per unit time became constant, a fuel permeability coefficient was determined from the following expression.

$$\frac{\begin{matrix}Fuel Permeability Coefficient ( ( g \cdot mm ) / ( {m}^{2} \cdot day ) ) = \\ [ Weight Reduction ( g ) ] \times [ Sheet Thickness ( mm ) ]\end{matrix}}{[ Opening Area ( {m}^{2} ) ] \times [ Measurement Interval ( da7 ) ]}$$

In the examples and the comparative examples, the following materials were used.

### Fluoroelastomer (1)

VdF/HFP/TFE ternary peroxide crosslinking type fluoroelastomer (fluorine content: 73 mass %, Mooney viscosity: ML1+10(100° C.)=40)

### Fluoroelastomer (2)

VdF/HFP/TFE ternary polyol crosslinking type fluoroelastomer (fluorine content: 69 mass %, Mooney viscosity ML1+10(100° C.)=45), mixture of crosslinking agent (bisphenol AF) and crosslinking accelerator (DBU-B); content of the crosslinking agent is 2.2 parts by mass based on 100 parts by mass of the fluoroelastomer; content of the crosslinking accelerator is 0.6 part by mass based on 100% by mass of the fluoroelastomer.

### Fluoroelastomer (3)

VdF/HFP binary polyol crosslinking type fluoroelastomer (fluorine content: 67 mass %, Mooney viscosity ML1+10(100° C.)=45), mixture of crosslinking agent (bisphenol AF) and crosslinking accelerator (DBU-B); content of the crosslinking agent is 1.5 parts by mass based on 100 parts by mass of the fluoroelastomer; content of the crosslinking accelerator is 0.2 part by mass based on 100% by mass of the fluoroelastomer.

### Fluoroelastomer (4)

VdF/2,3,3,3-tetrafluoropropylene binary peroxide crosslinking type fluoroelastomer (fluorine content: 62 mass %, Mooney viscosity: ML1+10(100° C.)=50)

### Magnesium Oxide:

Kyowamag 150 manufactured by Kyowa Chemical Industry Co., Ltd.

### Calcium Hydroxide:

NICC5000 manufactured by Inoue Calcium Corporation

### Triallyl Isocyanurate:

TAIC manufactured by Mitsubishi Chemical Corporation 2,5-Dimethyl-2,5-di(t-butylperoxy)hexane

PERHEXA 25B manufactured by NOF CORPORATION

### Carbon Black (1):

Thermax N990 manufactured by Cancarb Limited

### Carbon Black (2):

SEAST S manufactured by Tokai Carbon Co., Ltd.

### Cellulose Nanofiber

CNF (1): Cellenpia CS-01 manufactured by Nippon Paper Industries Co., Ltd.

### Carboxymethylated Cellulose Nanofiber (CM-CNF)

Fiber width: broad fiber width of several nm to several hundred nm

CNF (2): Binfis FMa-UNDP manufactured by Sugino Machine Limited
Median diameter: 5 to 10 μm
Degree of polymerization: 200
Fiber length: ultrashort
Amount of moisture: 4 to 8 mass %

### Example 1

With 100 parts by mass of a fluoroelastomer, 4 parts by mass of triallyl isocyanurate, 15 parts by mass of 2,5-dimethyl-2,5-di(t-butylperoxy)hexane, and 20 parts by mass of carbon black were mixed, then 10 parts by mass of CNF (2) were further mixed, and thereafter, the resulting mixture was kneaded with rolls by a usual method to prepare a fluoroelastomer composition.

The resulting fluoroelastomer composition was pressed under the forming conditions described in Table 1 and thereby crosslinked to obtain a sheet-like formed article having a thickness of 0.5 mm, and regarding the resulting sheet-like formed article, a fuel permeability coefficient was measured. A sheet-like formed article having a thickness of 2 mm was obtained in the same manner as above, and regarding the resulting sheet-like formed article, ordinary-state property and hardness were measured. The results are set forth in Table 1.

### Example 2

With 100 parts by mass of a fluoroelastomer, 3 parts by mass of magnesium oxide, 6 parts by mass of calcium hydroxide, and 13 parts by mass of carbon black were mixed, then 5 parts by mass of CNF (1) were further mixed, and thereafter, the resulting mixture was kneaded with rolls by a usual method to prepare a fluoroelastomer composition.

The resulting fluoroelastomer composition was pressed under the forming conditions described in Table 1 and thereby crosslinked to obtain a sheet-like formed article having a thickness of 0.5 mm, and regarding the resulting sheet-like formed article, a fuel permeability coefficient was measured. A sheet-like formed article having a thickness of 2 mm was obtained in the same manner as above, and regarding the resulting sheet-like formed article, ordinary-state property and hardness were measured. The results are set forth in Table 1.

### Examples 3 to 6 and Comparative Examples 1 to 4

A fluoroelastomer composition was prepared and a formed article was obtained in the same manner as in Example 1 or Example 2, except that formulation was changed as described in Table 1. The results are set forth in Table 1.

TABLE 1

| | | Compar- | Compar- | Compar- | Compar- | | | | | | |
|---|---|---|---|---|---|---|---|---|---|---|---|
| | | ative | ative | ative | ative | Exam- | Exam- | Exam- | Exam- | Exam- | Exam- |
| Formulation | | Example 1 | Example 2 | Example 3 | Example 4 | ple 1 | ple 2 | ple 3 | ple 4 | ple 5 | ple 6 |
| Fluoroelastomer (1) | part(s) | 100 | — | — | — | 100 | — | — | — | — | — |
| Fluoroelastomer (2) | part(s) | — | 100 | — | — | — | 100 | 100 | 100 | — | — |
| Fluoroelastomer (3) | part(s) | — | — | 100 | — | — | — | — | — | 100 | — |
| Fluoroelastomer (4) | part(s) | — | — | — | 100 | — | — | — | — | — | 100 |
| Triallyl isocyanurate | part(s) | 4 | — | — | 4 | 4 | — | — | — | — | 4 |
| 2,5-Dimethyl- | part(s) | 1.5 | — | — | 1.5 | 1.5 | — | — | — | — | 1.5 |
| 2,5-di(t- | | | | | | | | | | | |
| butylperoxy)hexane | | | | | | | | | | | |
| Magnesium oxide | part(s) | — | 3 | 3 | — | — | 3 | 3 | 3 | 3 | — |
| Calcium hydroxide | part(s) | — | 6 | 6 | — | — | 6 | 6 | 6 | 6 | — |
| Carbon black (1) | part(s) | 20 | — | — | 20 | 20 | — | — | — | — | 20 |
| Carbon black (2) | part(s) | — | 13 | 13 | — | — | 13 | 13 | 13 | 13 | — |
| CNF (1) | part(s) | — | — | — | — | — | 5 | 10 | — | — | — |
| CNF (2) | part(s) | — | — | — | — | 10 | — | — | 10 | 10 | 10 |
| Crosslinking | | | | | | | | | | | |
| conditions | | | | | | | | | | | |
| Press crosslinking | | 160° C. × | 160° C. × | 160° C. × | 160° C. × | 160° C. × | 160° C. × | 160° C. × | 160° C. × | 160° C. × | 160° C. × |
| | | 10 min | 45 min | 45 min | 10 min | 10 min | 45 min | 45 min | 45 min | 45 min | 10 min |
| Ordinary-state | | | | | | | | | | | |
| property | | | | | | | | | | | |
| 100% Tensile stress | MPa | 5.7 | 2.7 | 2.4 | 1.9 | 6.2 | 4.1 | 5.5 | 3.6 | 3.4 | 2.2 |
| Tensile strength | MPa | 20.1 | 12.3 | 10.5 | 20.1 | 17.5 | 9.2 | 8.1 | 9.4 | 8.6 | 18.0 |
| Elongation | % | 260 | 370 | 360 | 480 | 220 | 280 | 230 | 230 | 230 | 290 |
| Hardness (Shore A) | — | 80 | 60 | 62 | 61 | 81 | 64 | 69 | 63 | 65 | 63 |
| Fuel permeability | | | | | | | | | | | |
| (CE10, 40° C.) | | | | | | | | | | | |
| g · mm/m² · day | | 4 | 30 | 49 | 62 | 3 | 26 | 23 | 23 | 37 | 40 |

1. A fluoroelastomer composition comprising
a fluoroelastomer and a cellulose nanofiber, wherein
a fluorine content of the fluoroelastomer is 61 to 73 mass %, and
a content of the cellulose nanofiber is 1 to 50 parts by mass based on 100 parts by mass of the fluoroelastomer.

2. The fluoroelastomer composition according to claim 1, wherein an average fiber diameter of the cellulose nanofiber is 3 to 500 nm.

3. The fluoroelastomer composition according to claim 1, further comprising a crosslinking agent.

4. A formed article obtained from the fluoroelastomer composition according to claim 1.

5. A fuel hose obtained from the fluoroelastomer composition according to claim 1.
